(19) United States
(12) Patent Application Publication
(10) Pub. No.: US 2002/0100040 A1
(43) Pub. Date: Jul. 25, 2002

(54) Interactive entertainment

(75) Inventor: Stephen M. Bull, New York, NY (US)

Correspondence Address: BEVER HOFFMAN & HARMS, LLP, 2099 GATEWAY PLACE, SUITE 320, SAN JOSE, CA, 951101017

(73) Assignee: Cutlass, Inc.

(21) Appl. No.: 09/931,817

(22) Filed: Aug. 16, 2001

Related U.S. Application Data
(60) Provisional application No. 60/228,010, filed on Aug. 23, 2000.

(51) Int. Cl. H04N 7/173

(52) U.S. Cl. 725/24; 725/153; 725/36

(57) ABSTRACT

An interactive entertainment system (game) that provides rewards to a player by accumulating clues, wherein one or more clues provide a revenue node is described. Revenue nodes from various sources provide financial incentive for game generation, while complexity of play, team interaction, and rewards provide incentive for player involvement. A game engine is provided to provide core functionality for the use of game developers including the players themselves, thereby creating their own games.

### RELATED APPLICATIONS

This application claims priority to U.S. Provisional Application Serial No. 60/228,010 which was filed on Aug. 23, 2000.

### BACKGROUND OF THE INVENTION

1. Field of the Invention

A method of providing interactive entertainment is herein described. This method provides rewards to a player by accumulating clues, wherein one or more clues provide a revenue node.

2. Discussion of the Related Art

As people become more networked and connected in today's society, they become both more capable of receiving instantaneous information and more isolated from others physically. Interactive games provide a measure of socialization while taking advantage of the networked nature of today's society.

Diablo II is a computer game that allows solo play in the form of a character controlled by a player interacting with a computer simulated world. A social aspect is provided by allowing multiple players to network together and interact with the computer simulated world, in combatative or cooperative capacity. For example, a team of three players may network together solve tasks and complete the game. While incorporating social aspects into the game, Diablo II is wholly played within the framework of the computer simulated world. It would be desirable to have the team nature of the game extend to physical locations and interactions with other players.

Additionally, because Diablo II is a computer game, the primary source of revenue is from the initial sale of the game. It would be desirable to generate multiple source of revenue (or revenue nodes) from one instantiation of a game.

A recent live and interactive game, called Hide/Seek, was staged in New York city. In this game, a group of players, “fugitives”, were chosen to hide within the boundaries of the city. Other players were chosen to seek the fugitives. The seeking players were divided into physical seeking players that interacted within the physical boundaries of the city and virtual seeking players that interacted through the Internet.

Fugitives were assigned a day task by a command center that must be completed before sunset of that day. Fugitives receive money and points based on the order of the day task completion. Additionally, evening tasks are assigned to the fugitives involving eating, drinking, or merrymaking. Before the task is revealed to the fugitives and to the seekers, clues to the task are presented. Seekers may unravel the clues to the task to determine where to find the fugitives.

The fugitives had to stay at large for seventeen days while completing the tasks that were assigned to win the game. The seekers had to tag the fugitives, thereby preventing them from winning, to win the game. The prize for a seeker winning was split between the physical seeking player that tagged the last fugitive and the virtual seeking player that provided location information to the physical seeking player. The Hide/Seek game was sponsored by a company with a browser add-on that provides additional functionality to the browser.

The Hide/Seek game provides a means for highlighting the use of the browser add-on. However, no other revenue generating activities were shown during the execution of the game. It would be desirable to have multiple revenue nodes associated with an interactive game. Additionally, the Hide/Seek game focused online information on the Hide/Seek web site. It would be desirable to extend the browsing of Internet players to maximize the different advertising opportunities of the Internet.

The Hide/Seek game pitted one group of players in a contentious contest with other groups of players. Therefore, rather than racing against time, the fugitives were racing each other to complete tasks while hiding from the seekers. Thus, it is in a players best interest to sabotage the chances of another player. It would be desirable to focus an interactive game on racing the clock rather than contentious interactions with other players.

Another episodic on-line game in development entitled Majestic delivers messages to a player's telephone, fax machine, and email reminding the player to access the Majestic PC terminal video game to continue playing. The player is given the leading role in the center of a thriller in which the player interacts with other players in a fictional role and solves clues. It would be desirable to have a game that allows players to interact both in the physical world as well as on-line.

### SUMMARY OF THE INVENTION

An interactive, cross-platform, multi-level game is presented that leads players through a set of entertainment spaces using a series of clues and tasks, wherein the entertainment spaces, clues, and tasks may include revenue nodes such as product placement and product tie-ins for marketing purposes. The game attracts players by the challenging, entertaining, and rewarding aspects of the game and attracts sponsors with the targeted, informational, and interactive nature of player involvement, entertainment spaces, and product placements.

### BRIEF DESCRIPTION OF THE DRAWINGS

FIG. 1 is a block diagram of a set of three game spaces in accordance with one game embodiment in accordance with the present invention.

FIG. 2 is a flow diagram of a game in accordance with an embodiment of the present invention.

### DETAILED DESCRIPTION OF THE INVENTION

An interactive, cross-platform, multi-level game is presented that leads players through a set of entertainment spaces using a series of clues and tasks, wherein the entertainment spaces, clues, and tasks include revenue nodes such as product placement and product tie-ins for marketing purposes. The game attracts players by the challenging, entertaining, and rewarding aspects of the game and attracts sponsors with the targeted, informational, and interactive nature of player involvement, entertainment spaces, and product placements. A subscription embodiment of the game is largely self-promotional with the game sponsored by the players themselves through the subscription fees.

Interactive entertainment is defined as entertainment experienced by an entertainment user (player) and incorporates a multi-level game into various media accessible by the player. A multi-level game is a game having varying levels of difficulty, reward, and complexity. The multi-level game includes a number of clues provided to the player through various media. These clues include descriptions, such as physical real-world locations, Internet URLs, or other descriptions, and lead the player to the location of another clue, a reward, or some other experience. In one embodiment, a clue leads to an experience such as the location of a gathering of people. In another embodiment, a clue leads to a reward such as a free ice-cream cone.

An embodiment of the present invention includes assigning point values to each clue and tracking a particular player's accumulation of clue point values (i.e. accumulation of clues). Thus, players may be rewarded for accumulating clues by becoming an alpha player, directing the play of others, or by finding rewards. An alpha player is a player involved in the development of the multi-level game, and may be involved in the development of further multi-level games. Rewards may include cash, jewels, cars, or vacations. Winners of several multi-level games or several winners of the same multi-level game may be treated to a vacation together.

Revenue nodes are defined as areas available for revenue generation. Additional revenue nodes include television ad revenue and web site banner advertisement revenue. In one embodiment, players subscribe to a game service such that the subscription fee is a revenue node. In another embodiment, a sponsor company pays product placement fees as a revenue node. Several revenue nodes may be present in one instantiation of the game.

### DESCRIPTION OF VARIOUS ELEMENTS OF EMBODIMENTS

### Prizes

In one embodiment, the multi-level game is started by accessing an Internet web site wherein an information web page collects player information and an accreditation web page holds clues accumulated by that player. For example, the information web page may include a request for the zip code of the player. The zip code of the player may be used to determine the types of prizes available to that player. In one embodiment, the player may pick from a customized list of prize choices. For example, a player having a zip code within the boundaries of a large city might have as prize choices a first option to have a local delivery service deliver a prize and a second option for dinner at a local restaurant. In the same example, a player having a zip code in a rural area might have as prize choices an option to receive an item by regular mail and an option to print a gift certificate to a chain retail store. In this example, the multi-level game system dynamically determines what prizes are available to award a player based on the prizes available to the area covering that player's zip code. Other embodiments may use other information from the player to dynamically determine prizes.

In another embodiment, prizes are pre-defined and are awarded for successfully solving a set of one or more clues.

### Clues and Answers

Clues and answers may be hidden in different media as well as in different formats. For example, a clue may be hidden in an Internet web site. Such a clue may be hidden by setting the color of the clue (e.g., text of the clue) to the color of the background of the Internet web site so that the player must highlight the clue to obtain it. Placing the clue in the source code for the Internet web page such that it is not displayed until the source code is displayed may also hide such a clue. Clues may also be of the tradition riddle form, such that the actual clue is determined after solving, for example, a word puzzle.

In another example, a multi-level game clue-giver may enter a given “cell zone”. A cell zone is defined as an area covered by a particular cellular phone provider (or a similar local wire communication provider). The location of the clue-giver may be automatically provided to player devices such as pagers, cell phones, and personal digital assistants when the clue-giver enters the same cell zone as the players. The clue or clues given would then relate to the location of the multi-level game clue-giver. However, the clue-giver may only be in the cell zone for a predetermined period of time, thereby adding suspense and drama to the game. Players who solve the clue or clues can meet the multi-level game clue-giver for a prize or another clue.

As indicated above, an accreditation web page can store clues in an embodiment of the present invention. This accreditation web page interacts with the server such that the information contained on the accreditation page is available to the server. In a particular embodiment, many players have access to this accreditation web page. In this particular embodiment, players compete to complete a series of clues by providing the answers to the clues to an appropriate portion of the accreditation web page. Thus, a first player may enter the correct answer to the first clue on the accreditation web page (e.g. by being the player to input the correct answer in the shortest amount of time) but a second player may enter the correct answer to the second clue on the accreditation web page. Because the second player can see the correct answer previously entered by the first player, the second player can build upon those answers. As a result, the first player gets credit for the first correct answer, but the second player gets credit for the second correct answer. In this way, users compete against each other during the intermediate stages of the multi-level game as well as competing against each other for the final prize in a given instantiation of the multi-level game. In a variation of this embodiment, each player must correctly enter the correct answer to a first clue before that player can move on to the second clue.

Clues may be entered in various ways, including typing the answers into form fields in an internet web page and “dragging and dropping” clue solutions from a sponsoring internet web site to the accreditation web page storing the answers to the clues.

Players who fall behind in entering the correct answers to clues on the accreditation web page may be given ways to make up the deficiency in other ways. For example, players who fall behind may solve additional clues or perform some revenue generating actions to catch up in clue point values. Abuse of this option may be prevented by only allowing players logging a certain minimum number of correct answers to clues or a certain minimum amount of multi-level game time to be eligible to win the instantiation of the multi-level game. Players having different access speeds to the Internet may have access speed advantage normalized by the use of conventional compensatory techniques.

In other embodiments, incorrectly answered clues may lead players on a path other than the correct path. S pecifically, to enhance the excitement of the game, misdirection can be selectively provided to the players. Note that the use of a chat room (described in more detail below) may also contribute to some level of misdirection.

In a further embodiment, players may have to change behaviors or exhibit certain traits prior to continuing with a game. For example, a player may be told to perform an act of kindness. That player may have to verify the act of kindness performed before continuing on in the game.

Cross-channel play between players may include wireless personal digital assistants, computers, wireless telephones, telephones, facsimile machines, automatic teller machines, posted messages and clues, U.S. Mail, WebTV, WebVan, federal express, messengers, delivery services, and performers. For example, when a clue is found and solved, a player may use a cell phone to call a number and enter the identification of and solution to the clue.

The multi-level game may provide numerous advantages to its players. In one embodiment, the multi-level game may require players to access web features, thereby creating a learning environment. For example, the player may need to find clues in source code in a web site. If the player currently does not know how to access that source code, the user must learn that skill. In this manner, the multi-level game can empower its players with new skills.

The multi-level game can also enable interaction between players to solve clues. For example, the use of a chat room can facilitate communication between players. In this chat room, players can share information and form “trust alliances” for the collective solving of puzzles. As previously mentioned, the information shared in chat rooms may be incorrect. Thus, in one embodiment, to facilitate such “trust alliances”, authentication of the statements of players can be provided via authentication devices. In one case, an authentication device is implemented using a certificate issued by the provider of the multi-level game. In this manner, the authentication process promotes certain levels of trust to exist between various interacting players. Logically, alliances between players provide a valuable dimension to the multi-level game.

Another embodiment of the present invention promoting player interaction involves the rental of a post office box (or other mail delivery location). The clue is the combination of the post office box. Players solving the clue will crowd the area surrounding the post office box to get the clue. To promote sharing of the clue information, the point value assigned to the first person to enter the clue may depend on the number of people with whom the person has shared the clue, such that a sharing member may have a greater point value assigned to his or her clue solution than one who did not share. To facilitate latecomers, clues may be refreshed in the post office after a period of time (e.g., four hours or at the next scheduled mail delivery).

Another embodiment of the present invention involves a “Rave” or “happening”. In this embodiment, a number of players involved in a multi-level game are notified to come to a specific location for an event. Notification may take place by any means including computer email or chat room, short message service (SMS), pager notice, wireless personal digital assistant notice, telephone, and set-top boxes. At one such event in an embodiment of the present invention, a multi-level game coordinator assigns roles to the players. The players then interact with each other to determine the role to which they were assigned. In one variation, once entertainment roles are determined, each player finds another player with a compatible role. These coupled players are then paired on a date. In this way, players may interact in a safe and public manner. In one embodiment, a wireless device associated with each player provides a medium for each player to receive more clues, exchange information, and interact with the entertainment coordinator.

Note that the multi-level game may be self-perpetuating in that one player may solve a clue and then generate another clue with another or the same answer for another player.

### Weather

Delivered clues are dynamically adjusted and delivered to players based on game location weather conditions. Weather including rain or snow causes more indoor clues to be delivered to the player. Cold winter weather causes clues that are closer together, thereby lessening player exposure to the cold winter weather, while warm summer weather sends players to rivers that border on the physical boundaries of game play, thereby maximizing player enjoyment of the warm summer weather.

### Location

Players can subscribe to a notification service that then notifies them of local gaming opportunities. Thus, players out for a walk might be notified of the start of a nearby game, or players on vacation driving down a highway may be notified by a pager alert that a game potentially appealing to that player is located nearby. In this way, a single subscriber can be alerted to the presence of a nightclub and a family on vacation can be alerted to the presence of a cowboy family activity opportunity according to their preferences. In another example, players that are not subscribed to a notification service may be notified by advertising that a game is available for play nearby.

### Revenue

Revenue may be generated by various methods including banner ads, agreements with sponsors, and payments from players. As a result, many revenue nodes are possible in any instantiation of the game. Players having identifiable advertisement profiles may have advertisements targeted to their profiles. This targeted advertising can be charged at a higher rate than typical advertisements.

Clues gleaned from commercials leading into a television program and then entered in a form providing sufficient proof of viewing or driving traffic to online web sites provide additional sources of revenue from those advertisers. For example, a clue may be to note the product promoted in the lead-in commercial to a given television program. The player would answer the clue by entering the name of the product into an appropriate medium. Advertisers would pay for the privilege of having their product advertisements validated in such a way, thereby promoting brand recognition among players.

In another embodiment, the clue could be the tenth word in a character's speech at a particular point in a television show, a movie, or a movie available for rent, for example. In this embodiment, revenue may be generated by the increase in patronage or traffic produced by affiliation with the game. For example, if a clue were provided by a certain movie currently available for rental from video stores, then a portion of the spike in revenue generated by player rentals of that movie could be attributed to playing the multi-level game. In a similar embodiment, a portion of the spike in revenue generated by screenings of a particular movie at a movie theatre could be attributed to playing the multi-level game. While records from a database of the game organizers can provide one form of validation, further validation of viewing a movie could include mailing in a rental receipt/ticket stub or entering an identifying code from the rental receipt/ticket stub into an on-line database. Additional compensation in the form of a coupon or some other prize could be provided for the cooperation of the player.

Another form of revenue generation could involve sending players to a business location for additional clue gathering. For example, a clue may direct players to go to a particular restaurant. In one embodiment, the Nth player to reach the restaurant receives a free meal. Other players arriving earlier or later may receive a discount on their meal should they choose to stay and eat at the restaurant. Alternatively, the players may be sent on to a next restaurant to continue the multi-level game.

In yet another form of revenue generation, identifiable characters created for the multi-level game may be used to generate more interest in playing the game. For example, the characters can be made into promotional products provided at fast food chains. Alternatively, the characters can be used in a media campaign to introduce the multi-level game in new geographic areas.

Reusable elements of individual multi-level game design may also be packaged and sold as a game-engine (tools) for the creation of other multi-level games created by licensed game designers. Game designers may define their own game from these tools, defining also their own methods of revenue generation. These games may be listed in a central gaming opportunities database storing for some fee. In one embodiment, players subscribe to a notification service alerting them to nearby gaming opportunities from the database. For example, players may be notified of a nearby live-action game based on the Dungeons & Dragons™ game.

Smart cards or smart items may provide additional revenue nodes. For example, a player may receive a clue in conjunction with a particular purchase at a store, thereby promoting more sales of that product. In this example, the clue could also entitle the player to receive a discounted item or receive a prize in the store. In another embodiment, sales of any product in a particular store can generate additional clues. In this manner, shopping by players in that particular store is promoted.

In yet another embodiment, the clue may be presented in either a standard or optimized manner. For example, the speaker in a voice clue provided in a standard manner may speak extremely slowly. The clue presented in the standard manner is “free”. However, a clue presented in the optimized manner incurs some form of “payment”. In one example, the player must listen first to an advertisement regarding a new movie release in his/her city, but will then receive the clue via a normal voice or otherwise receive the clue in an optimal manner. Paying a fee results in player receipt of the clue without the advertisement, or receiving the clue in some other expedited manner.

In another embodiment, players may be requested to stay turned to a radio station or stay on one web site to get another clue within some period of time, thereby encouraging more players to listen to that radio station or surf that web site.

In yet another embodiment, companies can be licensed to start their own multi-level games. For example, a team building exercise in a company could make use of the building blocks of the multi-level game framework to facilitate creative thinking and group interaction.

In yet another embodiment, the broadcast rights of the multi-level game in progress could provide valuable advertising revenue. In this embodiment, various happenings or locations would be filmed, thereby providing entertainment for viewers at home craving reality-based programming. Moreover, such viewing, which may well include shots of friends or family, may well encourage these same viewers to participate in the multi-level game.

### Game Engine

As described above, the separate licensing or sale of the game engine allows others to design their own game. A teenager can download the game engine and design a game customized for his friends showcasing items he has for trade while a business executive can download the same game engine and customize it for her team retreat showcasing company products to familiarize the team with the company products.

The game engine can also be designed with the flexibility to adapt the flow of the game or other aspects of play in successive instantiations of the game or even within one instantiation of the game. The game engine also allows flexibility within the game. Thus, the metaplayers may change the rules or context of the game during the game, such as to speed up the game, improve flow of players through the entertainment space, etc.

### FIRST EMBODIMENT

In a first embodiment of the game, teams of players including players physically located in a game space and players at home compete for a prize of gold Sacagaweas. Each team solves clues, collects artifacts, and searches the Internet to finish the game. Thus, the focus on the first embodiment of the game is on individual effort, rather than competitive advantage by hindering other teams. Some of the clues are time sensitive, and so are removed after a time period, making the game time-based. A metaplayer defines clues and runs the game, thereby maximizing the directability of the players through advertising spaces. Thus, players can be can directed to interact with or search around products and information. For example, physical location players can be directed to enter a store and talk to a clerk to solve a clue and Internet players can be directed to websites and told to garner some piece of information from an advertisement found there.

The game is advertised in several ways, including handing out cards around the location of the game, leaving flyers in cabs, putting flyers in local shops, and providing information on Internet web pages. Players pre-register for the game through their WAP-enabled phones, wireless devices, or on the Internet. Players may register individually or as a pre-defined team. A metaplayer defines additional teams comprising individual players that are not a member of a pre-defined team. The teams are comprised of a group of physical players (e.g. that search the physical game space) and a group of one or more virtual players (e.g. that search the Internet and help enter clue answers).

Teams are provided with an instruction sheet containing the rules of the game, emergency contact information, a map of the play area, and the online location of the clues. The back side of the instruction sheet has a large logo suitable for authentication by holding the instruction sheet up to a web camera as well as providing self-promotion during the game (both to physical and internet viewers as well as to the players themselves). The instruction sheet defines the rules of the game as solving six of eight opening clues and then solve the final clue to discover the treasure chest and the secret code to open it. The clues are therefore all accessible at the start of the game. When the game begins, teams log into the web page with their WAP enabled phones, wireless PDAs or on a computer to find the eight opening clues.

The clues are presented in the form of a task, several hints, an answer prompt, and a success message. The initial access of a clue results in a web page displaying the task to be accomplished. Enabling the access of the first clue at a specific time on a specific date gives all players an equal starting position. Note that the starting time and date may also coincide with other activities in the area, such as New Years Day games played prior to the start of or as an alternative to watching the Super Bowl. Throughout the task, several hints are given to further guide the players to the correct answer. An answer prompt is displayed to ensure that players are completing the correct task. Upon correct entry of the answer, a success message is displayed to the players.

A first task utilizes a telephone number shown on a web site displayed with a computer web browser, digital cell phone display, or a wireless personal digital assistant (PDA) display, or heard on a telephone receiver using a voice markup language (VXML). The web site contains the information shown in Table NY_Task_{—}1 (web page titles are shown in bold):

TABLE NY_Task_1
Task Number 1

| | |
|---|---|
| Task | Keenan |
| | What is Keenan's first |
| | name? |
| | 1-212-555-1234 |
| Hint 1 | Hint |
| | Indian Campaigns |
| Hint 2 | Look around |
| | Bronze plaque |
| Hint 3 | Neon |
| | Flag |
| Answer Prompt | Keenan's first name: |
| Answer | Bartholomew |
| Success Message | Good work soldier |

Calling the telephone numbers delivers an audio recording of the military dirge “Taps” played on the trumpet. The answer is on a bronze plaque on the back exterior wall of the United States Armed Forces recruiting booth at the intersection of 44^{th} and Broadway. Bartholomew Keenan was a soldier from New York City who received recognition and medals as a trumpeter in the United States Army Indian Campaigns.

A second task also utilizes a telephone number displayed on a web site. The web site contains the information shown in Table 2 (web page titles are shown in bold):

TABLE NY_Task_2
Task Number 2

| | |
|---|---|
| Task | Last word |
| | What is the last word? |
| | 1-212-555-1245 |
| Hint 1 | Hint |
| | What is the final word |
| | in the outgoing |
| | message? |
| | 1-212-555-1245 |
| Hint 2 | Is |
| | What is the last word? |
| | 1-212-555-1245 |
| Hint 3 | Last |
| | What is the last word |
| | 1-212-555-1245 |
| Answer Prompt | Last word: |
| Answer | games |
| Success Message | Play! |

Calling the telephone numbers delivers an out going answering machine message of a Broadway ticket broker who agreed to provide Broadway show passes in exchange for Cutlass game players who listen to his promotional message. The last word of the message was “games.” The hints reinforce a clear message to the new user to listen for the last word in the answering machine message.

A third task requires players to ascertain that the answer to the clue could be found in a nearby record store. The web site contains the information shown in Table 3 (web page titles are shown in bold):

TABLE NY_Task_3
Task Number 3

| | |
|---|---|
| Task | Stories |
| | Track 9 in Stories |
| Hint 1 | Is |
| | Japanese Zero |
| Hint 2 | Is |
| | Harvey |
| Hint 3 | City |
| | The Sea |
| Answer Prompt | Track 9: |
| Answer | Kamikaze |
| Success Message | Huzzah huzzah |

In searching for the answer to the clue, players look through store merchandise, thereby providing exposure of the merchant's wares to potential customers. “Stories” is the first word in the music CD “Stories From The City Stories From The Sea” by recording artist P. J. Harvey. The ninth music track on the CD is “Kamikaze”. A hint of “Japanese zero” is a World War II Japanese fighter/bomber aircraft used by the “Kamikaze” pilots.

A fourth task requires players to ascertain that the answer to the clue could be found in the Warner Brothers™ store at 42^{nd} street. The web site contains the information shown in Table 4 (web page titles are shown in bold):

TABLE NY_Task_4
Task Number 4

| | |
|---|---|
| Task | Kiss |
| | Who is kissing who on |
| | Broadway? |
| Hint 1 | Hint |
| | 42^{nd} Street |
| Hint 2 | Is |
| | Statue |
| Hint 3 | Squash |
| | Air squash |
| Answer Prompt | Her name: |
| Answer | Lola |
| Success Message | Smack |

In searching for the answer to the clue, players look through store merchandise, thereby providing exposure of the merchant's wares to potential customers. Outside the Broadway entrance to the Warner Brothers store stands a statue of Bugs Bunny kissing “Lola” Bunny. While Bugs Bunny is a familiar character to most people, players have to enter the Warner Brothers store to ask the name of Lola, his co-star in the movie Space Jam. Space Jam was about an outer space basketball championship, hence the “Air squash” hint. The hint and task associated with the movie Space Jam additionally provides exposure to the film for potential entertainment consumers.

A fifth task provides many opportunities for product placement. The web site contains the information shown in Table 5 (web page titles are shown in bold):

TABLE NY_Task_5
Task Number 5

| | |
|---|---|
| Task | Dead Reckon |
| | Shubert Theater STAGE |
| | DOOR, 94 paces N, 18 |
| | paces E from West Side |
| | Story, Esc to 8, 10 |
| | paces N, 40 paces E. |
| Hint 1 | Hint |
| | Stage door is in the |
| | alley |
| Hint 2 | Is |
| | Esc is Escalator |
| Hint 3 | M-F |
| | M ask F for assistance |
| Answer Prompt | How many stalls in |
| | women's bathroom? |
| Answer | 4 |
| Success Message | Flush |

“Dead Reckon” is short for deduced reckoning navigation. This task begins opposite the stage door in Shubert's Alley. The players must ask local shopkeepers for the landmark address. “94 paces N” takes players to a mural of the “West Side Story” Broadway musical in a covered alleyway of the Mariott. Players are thus exposed to the opportunity to see the “West Side Story” Broadway musical. “18 paces E” takes players to “Esc (“Escalator”) to the 8^{th} floor. “10 paces N” and “40 paces E” puts players outside the women's bathroom at a popular Mariott tourist location having a revolving restaurant overlooking Broadway and other New York scenery. Players are thus exposed to potential dining and entertainment opportunities in solving the clue. “M-F” suggests males ask females for assistance to discover the answer. This task brings players into this part of the Marriott that they may not have know about, which makes a product promotion event within the course of game play.

A sixth task also provides many opportunities for product placement and advertisement. The web site contains the information shown in Table 6 (web page titles are shown in bold):

TABLE NY_Task_6
Task Number 6

| | |
|---|---|
| Task | Find Pirate |
| | Find pirate in Times |
| | Square |
| Hint 1 | Hint |
| | Look around or contact |
| | someone on web peering |
| | through www.earthcam.com |
| | Times Square NYC |
| | camera windows. |
| Hint 2 | Need |
| | Avast. You need a key |
| | to a locker. |
| Hint 3 | Doll |
| | The pirate ain't no |
| | doll. After you find |
| | the pirate you need to |
| | find the doll. |
| Answer Prompt | What is doll's name? |
| Answer | Fifi |
| Success Message | Aye! |

The pirate is a game organizer standing in front of the www.earthcam.com web camera outside of MTV studios on Broadway. He carries a large Cutlass™ placard advertising the company organizing the game to help players as well as solicit new business. When challenged by a player, the pirate gives him a key to a locker at a nearby video game arcade parlor, providing an opportunities to cross-promote products and services. Upon opening the locker, the player finds several product placement beverages to share with his team members and a curious small doll. In one variation of this embodiment, a popular cartoon action figure used as the doll provides additional product placement opportunities. The doll has the name “Fifi” written on its base.

A seventh task requires a purchase of an advertised product for completion. The web site contains the information shown in Table 7 (web page titles are shown in bold):

TABLE NY_Task_7
Task Number 7

| | |
|---|---|
| Task | Bazooka |
| | Something to chew has |
| | a PO Box, too. |
| Hint 1 | Hint |
| | Joe |
| Hint 2 | Is |
| | Bubbble |
| Hint 3 | Ha |
| | Ha, ha! |
| Answer Prompt | Bazooka Joe and Gang |
| | PO Box number: |
| Answer | 485 |
| Success Message | Right! |

A player needs to figure out that he should buy and open a package of Bazooka Bubble Gum to find the PO Box number associated with the comic inside. This clue provides both advertising and purchase dollars for a cross-promotion with Bazooka Bubble Gum.

A eighth task provides many opportunities for product placement. The web site contains the information shown in Table 8 (web page titles are shown in bold):

TABLE NY_Task_8
Task Number 8

| | |
|---|---|
| Task | Jingle |
| | Coffee song ends how? |
| Hint 1 | Hint |
| | Get elevated |
| Hint 2 | Chalk |
| | The first bite of |
| | chocolate is all full |
| | of nuts. |
| Hint 3 | Fresh |
| | You have to be old to |
| | have seen its paint |
| | fresh |
| Answer Prompt | The final word shown |
| | in the jingle is |
| Answer | buy |
| Success Message | Satisfaction |

While most Times Square billboards are modern, the oldest signage in Times Square displays the lyrics to the Chock-full-o-nuts coffee jingle. Some players find the last word in the painted lyrics, while others may telephone someone, such as parents, for the information.

After players successfully solve six out of the eight clues described above, they receive the final task required to discover the location of the hidden treasure chest and win the contents of the chest.

A final task provides many opportunities for product placement. The web site contains the information shown in Table 9 (web page titles are shown in bold):

TABLE NY_Task_9
Task Number 9

| | |
|---|---|
| Task | Okay, you got the 6 of |
| | 8. Here is the final |
| | task. Find treasure |
| | chest and receive |
| | final instructions to |
| | open it by asking for |
| | the guardian's name. |
| Hint 1 | Hint |
| | Face the longest road. |
| | Go to CA dreamers of |
| | yore street, where the |
| | artsy spy, stabbed in |
| | the eye, might drink. |
| | When you get to the |
| | treasure chest, ask |
| | for the guardian's |
| | name. |
| Hint 2 | Web visual |
| | Get visual location |
| | clue at |
| | ctlss.com/clue.html. |
| | Call a friend of a |
| | Cutlass web player, or |
| | go to local cyber |
| | café. When you get to |
| | the treasure chest, |
| | ask for the guardian's |
| | name. |
| Hint 3 | Spear |
| | The spear drinks here. |
| | When you get to the |
| | treasure chest, ask |
| | for the guardian's |
| | name |
| Answer Prompt | Treasure guardian's |
| | name |
| Answer | Terese |
| Success Message | Telephone 1-917-555- |
| | 1567 + keypad last four |
| | digits of your cell |
| | phone number + # and |
| | wait approx. 1 minute |
| | for green light to |
| | open Treasure Chest. |

The Treasure Chest was hidden within the 3^{rd} floor bar of the Playwright's Tavern on 49^{th} Street between Broadway and 7^{th} Avenue. The web page titles “Hint” and “Spear” refer to the playwright Christopher “Shakespeare” Marlowe, who was wounded in the eye in a bar brawl. The web page title “Web visual” points to a web and wireless PDA image fragment clue of the tavern's sigh - some players go to the 42^{nd} Street easyEverything Internet café to see this clue for themselves, others call an html enabled friend or family member to look for it instead, and the remainder concentrate on the other clues and footwork. After entering the final clue answer, a winning team member telephones the number indicated in the “Success Message” that in turn triggers an ordinary pager within the treasure chest to activate its pager vibrating motor that in turn provides the electronic signal to open the treasure chest lock. After seeing the lock indicator light illuminate green, the winner(s) then opens the chest, removes, and divides the treasure.

Clues are initially provided to each team. Solving these clues lead to additional clues, thereby advancing the game. Clue examples include determining the female character statue being kissed by Bugs Bunny at a Warner Brothers store and determining the number of stalls in the women's bathroom at the Marriott hotel.

The progression of the game can be videotaped for live or later airing. Multiple cameras may be utilized to obtain many different camera angles. As a result, camera angles present backgrounds of existing billboard advertising to provide further potential advertising to a company and may be sold to additionally increase revenue.

### SECOND EMBODIMENT

In a second embodiment of the game, a game space is set up at a convention. Players may sign up to play the game immediately using a cell phone. A primary sponsor provides a majority of the products and information to populate the game space. The clues are then defined such that the players have to evaluate the applicability of several marketing tie-ins in a particular space to solve the clue. For example, a clue of “blue label power” requires that a player search the products within the space, evaluating each to determine if any has a blue label or is associated with power. Thus, these products within the space receive more investigation in the course of the game than they would by casual observance. In such an example, a power adapter contained within a blue box may be the correct answer. As a result, product placement has visibility outside the scope of the answer to the clue.

A first clue draws attendees to a particular presentation. The web site contains the information shown in Table CTIA_Clue_{—}1 (web page titles are shown in bold):

TABLE CTIA_Clue_1
Clue Number 1

| Title | KEYNOTE |
|---|---|
| Clue | What is the final word |
| | in Hellstrom keynote |
| | address? |
| Hint 1 | Kurt |
| | Kurt Hellstrom is |
| | President, LM Ericsson |
| Hint 2 | Loves |
| | Kurt loves telephones. |
| Hint 3 | Ericsson |
| | Ericsson has the final |
| | word. |
| Answer | Goodnight |

This clue is designed to draw crowds to the keynote address delivered by the CEO of Ericsson. The final word in the speech is entered into the answer field for the game.

A second clue focuses players' attentions to products and technology of a sponsor company. The web site contains the information shown in Table CTIA_Clue_{—}2 (web page titles are shown in bold):

TABLE CTIA_Clue_2
Clue Number 2

| Title | GIRLS |
|---|---|
| Clue | Girls, girls, girls. |
| Hint 1 | <none> |
| Hint 2 | <none> |
| Hint 3 | <none> |
| Answer | 3G |

This clue is designed to focus players attention on Ericsson technology and activities within the Ericsson pavilion, as well as promote recently deployed Ericsson “3G” technology.

A third clue educates players about new consumer technology. The web site contains the information shown in Table CTIA_Clue_{—}3 (web page titles are shown in bold):

TABLE CTIA_Clue_3
Clue Number 3

| Title | TAB |
|---|---|
| Clue | Pick up the tab with |
| | four letters |
| Hint 1 | <none> |
| Hint 2 | <none> |
| Hint 3 | <none> |
| Answer | ePay |

This clue is designed to familiarize players with the “epay” service, which allows a user to pay for a purchase using a cellular telephone.

A fourth clue educates players about new consumer technology and applications. The web site contains the information shown in Table CTIA_Clue_{—}4 (web page titles are shown in bold):

TABLE CTIA_Clue_4
Clue Number 4

| Title | HORSE |
|---|---|
| Clue | Swedish horse race- |
| | enabling |
| Hint 1 | 1999 |
| | There were bettors |
| | following mudders. |
| Hint 2 | <none> |
| Hint 3 | <none> |
| Answer | Chatboard |

“Chatboard” is a miniature keyboard Ericsson cell phone accessory that allows racetrack denizens to exchange betting tips more easily. The use of the term “Chatboard” as a clue both educates players as to the availability of the application as well as with it's use.

A fifth clue educates players about new consumer technology. The web site contains the information shown in Table CTIA_Clue_{—}5 (web page titles are shown in bold):

TABLE CTIA_Clue_5
Clue Number 5

| Title | SEXY |
|---|---|
| Clue | Hearth throb |
| Hint 1 | Extreme |
| | Extreme messaging |
| Hint 2 | Info |
| | Availability info |
| Hint 3 | <none> |
| Answer | iPulse |

“ipulse” is a Short Messaging System (SMS) technology product that is introduced to players via the clue.

A sixth clue educates players about new consumer technology. The web site contains the information shown in Table CTIA_Clue_{—}6 (web page titles are shown in bold):

TABLE CTIA_Clue_6
Clue Number 6

| Title | Star |
|---|---|
| Clue | Almost Starwars but |
| | secure |
| Hint 1 | <none> |
| Hint 2 | <none> |
| Hint 3 | <none> |
| Answer | Jalda |

This clue is designed to familiarize players with the “Jalda” service, which permits users to purchase merchandise from vending machines with cell phones.

A seventh clue educates players about new consumer applications. The web site contains the information shown in Table CTIA_Clue_{—}7 (web page titles are shown in bold):

TABLE CTIA_Clue_7
Clue Number 7

| Title | HAPPY? |
|---|---|
| Clue | Are you just happy to |
| | see me or do you just |
| | want my biz card? |
| Hint 1 | Ring |
| | Exchange ring signals |
| Hint 2 | Swap |
| | Swap cards |
| Hint 3 | <none> |
| Answer | R320 |

“R320'is a new Ericsson cell phone allowing users to swap business cards and distinctive incoming telephone ring signals.

A eighth clue educates players about third party services. The web site contains the information shown in Table CTIA_Clue_{—}8 (web page titles are shown in bold):

TABLE CTIA_Clue_8
Clue Number 8

| Title | BALLOONIST |
|---|---|
| Clue | A balloonist sneaks |
| | away from it. |
| Hint 1 | WIZARD |
| | and Dorthy leave |
| | together in one |
| Hint 2 | <none> |
| Hint 3 | <none> |
| Answer | oz.com |

“Oz.com” is a third party services supply company that Ericsson is supporting.

After a player has solved two of the eight clues described above, they receive the final task required to discover the location of the hidden treasure chest and retrieve their winnings.

A final clue educates players about new consumer technology and applications. The web site contains the information shown in Table CTIA_Clue_{—}9 (web page titles are shown in bold):

TABLE CTIA_Clue_9
Clue Number 9

| Title | FINAL |
|---|---|
| Clue | Find the pirate. Read |
| | the LED on the UFO. |
| Hint 1 | Frisbee |
| | Catch it to see it. |
| Hint 2 | Hangout |
| | The pirate hangs out |
| | with the Ericsson |
| | crew. |
| Hint 3 | <none> |
| Answer | FELIX |

The finishing player has to find the pirate, thereby promoting the game organizer. The game monitor is playing with an “E*Writer”, a Frisbee-like flying disk that has an eight light emitting diode (LED) display incorporated into the edge of the disk. The use of the E*Writer provides a product promotion opportunity. When the E*Writer is thrown and spun as part of the Frisbee-like pass, the disk displays a message. Specifically, the E*Writer displays the word “FELIX”. The message spelled out in the LED display of the E*Writer provides an additional opportunity for product promotion. The finishing player has to catch the disk to see the final answer required to win the game. Entering the final answer into a WAP-enabled cell phone, wireless PDA or other wireless device, or into an HTML browser on a personal computer announces to the player that he is the winner while also announcing to the rest of the players that the game is over. Additionally, entering the correct answer opens the treasure chest to allow the player to remove the prize. The treasure chest is coupled to the input device (e.g. by a wireless telephone to a treasure chest having a static IP address) such that entry of the correct word causes the treasure chest to open. The contents of the treasure chest are the player's winnings.

This embodiment of the game includes an interactive element such that the players themselves can generate their own clues as well as answers to those clues. For example, a player may have noticed a particular cellular phone provider at the convention. The player then may consider the products and information related to that cellular phone provider to come up with a new clue for the game that will be solved in the next round of the game by some other player. These player-generated clues are then adapted into the game. In this way, players additionally interact with products and information in the game space while creating new clues.

A flexible game engine makes this embodiment of the game controllable in real-time, such that a metaplayer can alter the parameters of the game. Thus, new clues may be added and the requirements for progressing from one game space to another within the game can be changed to, for example, direct play near additional advertising opportunities or to speed up or slow down the course of play.

In a particular variation of this embodiment, visitors to an adventure zone (game space) co-branded by a wireless manufacturer and a game company are initially notified that they are players in an adventure zone. They immediately may be given clues on their wireless device or directed to a set of clues on a nearby wall-mounted display. Players must solve a set number of the given clues to win the game. The clue of “Heart Throb” causes players to examine the game space to make an association between the clue and the environment of the game space. Players thus investigate products and pitches (information) in the game space to determine the relevance between the items and information and the clue. For example, because if the short messaging system I-Pulse is featured in the this embodiment of the game space, then this system could be the correct answer to the clue of “Hearth Throb”.

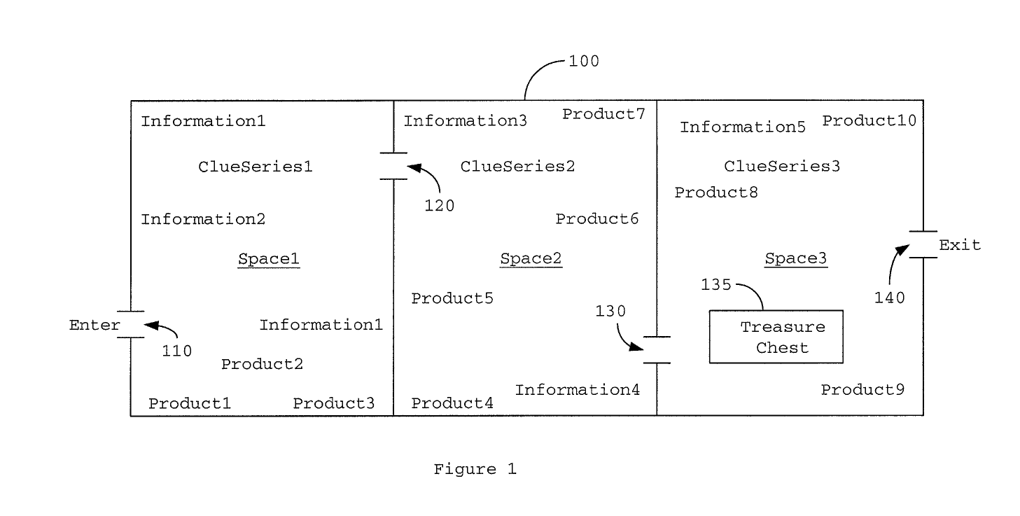

FIG. 1 is a game space in accordance with the second embodiment of the present invention. Game space 100 includes three sub-spaces Spacel, Space2, and Space3. Each sub-space includes product information, placements, and a series of related clues. Thus, sub-space Spacel includes information Information1, Information2, and Information3, product placements Product1, Product2, and Product3, and series of clues ClueSeries1. Players enter the game space through entrance 110 and receive one or more clues in ClueSeries1. Solving the one or more clues requires interaction with information Information1, Information2, and Information3 and products Product1, Product2, and Product3. When a pre-defined number of clues have been solved, the players move into sub-space Space2 thorough entrance 120.

Players in sub-space Space2 receive one or more clues in ClueSeries2. These clues require interaction with information Information4 and Information5, and products Product4, Product5, Product6, and Product7. When a predefined number of clues have been solved in sub-space Space2, players move into sub-space Space3 through entrance 130. Players in sub-space Space3 receive one or more clues in ClueSeries3. These clues require interaction with information InformationG and products ProductS, Product 9, and Product1O. When a predefined number of clues have been solved in sub-space Space3, the key to treasure chest 135 has been obtained. Players then open treasure chest 135 with the key. The key to treasure chest 135 may be a password, a physical key, or any other unlocking mechanism. The game reward is stored in treasure chest 135. Players then exit the game space through exit 140.

In one variation of this embodiment, boundaries between game sub-spaces represent physical boundaries between groups of product information, placements, and clues. For example, sub-spaces Space1, Space2, and Space3 may exist in separate rooms wherein players move through the rooms. In another variation of this embodiment, sub-spaces Space1, Space2, and Space3 represent levels of increasing difficulty in play. For example, solving the required number of clues in sub-space Spacel allows a user to move from a novice level of difficulty to an intermediate level of difficulty in sub-space Space2.

### THIRD EMBODIMENT

In a third embodiment of the present invention, a game space (adventure zone) can be a town having a tourist attraction applicable to different categories of players. The entertainment space may be divided into multiple overlapping adventure zones, such as a picturesque cowboy town for family fun, antique shops for antiquing adventures, and a lively downtown nightclub for dancing singles. The town can generate games for each of these adventure zones showcasing local and nationwide merchants using a provided game engine.

Players can be recruited for adventure zones by subscribing to a notification service and then being notified of adventure zone opportunities. In one embodiment, a service is offered players to alert them to nearby entertainment space opportunities. For example, in driving down a highway, a pager alert can notify a player that an entertainment space that is potentially appealing to that player is located nearby (e.g. an antique mall for a player that enjoys antiques). In this way, a single subscriber can be alerted to the presence of a nightclub and a family on vacation can be alerted to the presence of a cowboy family activity opportunity according to their preferences. In another example, players that are not subscribed to a notification service may be notified by advertising that an entertainment space is nearby.

Revenue can be generated in several ways, including the product placements and a subscription to a notification service by the owner or operator of the entertainment space.

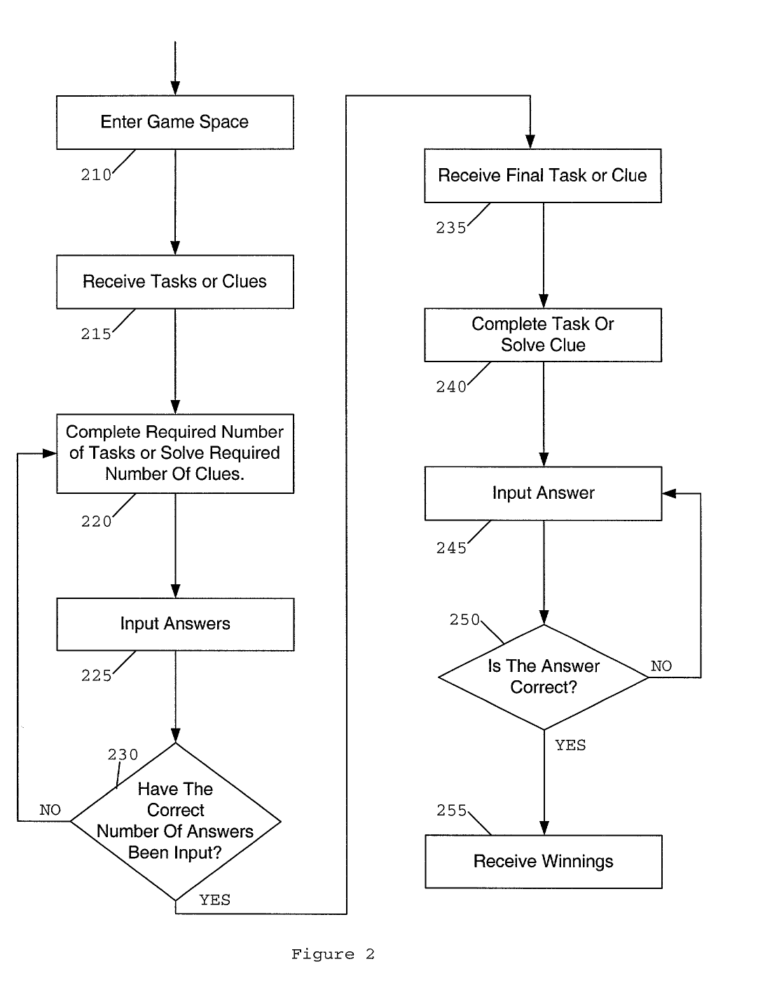

FIG. 2 is a flow diagram of a game according to one embodiment of the present invention. Players enter the game space in step 210. Once the game has started, players receive their tasks or clues in step 215. Players complete the required number of tasks or solve the required number of clues in step 220. In completing the tasks and solving the clues, players are directed through advertising spaces, familiarized with products and services, and presented with consumer information. Players input answers in step 225 and find out if their answers are correct in step 230. Incorrect answers require that the player input another set of answers. However, correct answers lead to the receipt of the final task or clue in step 235. The player completes the task or solves the clue in step 240 and inputs the answer in step 245. If the answer is incorrect, step 250 requires that the player go back to step 245 and input another answer. However, if the answer is correct, the player receives the winnings of the game in step 255.

### OTHER EMBODIMENTS

Other embodiments of the multi-level game may include various forums and interaction between players.

In one embodiment, an Internet rally requires the player to go from portal to portal during a specific time window in order to collect clues. For example, the twentieth person to arrive at a site may get a point or get twenty points, with the nineteenth and the twenty-first people to arrive getting nineteen points, and so on until no more points are awarded. This rally idea may also be applied to restaurants in which a first restaurant is encoded into a clue. The twentieth person reaching the first restaurant may receive a free meal. An accreditation restaurant is named an hour later. The tenth person reaching the accreditation restaurant may receive a free meal. And so on, until all participating restaurants are listed and players win free meals, eat at the restaurants anyway, or discontinue playing the multi-level game.

In another embodiment, a peer-to-peer game where a token is exchanged between players is contemplated. For example, a list may be exchanged between players. Each player adds an identifier to the list. At some point, the list is either returned to the multi-level game coordinator or removed from play. Players on a list returned to the multi-level game coordinator are rewarded in some fashion. In another example, a web camera broadcasts a picture of a location. Clues point to the coordinates of the location while the camera image itself might show some clearly recognizable advertisement to aid players in finding the location as well as generating a source of advertising revenue to sponsor some portion of the game. The first player or team of players to correctly identify the location is rewarded in some fashion. Note that the various embodiments described herein may be broadcast to the public using a web camera or other media. Similarly, self-generating content may be employed, where a first player leaves a clue for later players rather than the multi-level game coordinator or metaplayer.

In yet another embodiment, specific destinations or themed destinations may use only clues appropriate to the theme of the destination. For example, a wilderness theme park may include clues exclusively relating to the theme park, items in the theme park as clues, or locations within the theme park as clues. Another example includes acquiring additional information on items in the destination after solving clues relating to the destination. For example, after solving a certain number of clues at a particular destination, thereby visiting various locations within that destination, players may stop by the gift shop to retrieve a prize or receive a discount on a purchase. Note that information presentation of content may be tailored to players based on their assigned profiles. For example, a child may hear clues described in a child's voice to provide familiarity. In such a way, children may be drawn through an exhibit space or players may be rewarded for finding a certain number of icons at a destination.

The embodiments described above are illustrative only and not limiting. For example, in other embodiments of the invention, additional elements such as secured login and data encryption may be added to the Internet play of the game. Moreover, different revenue nodes may be present in other embodiments of the game. Other embodiments and modifications to the system and method of the present invention will be apparent to those skilled in the art. Therefore, the present invention is limited only by the appended claims.

1. An interactive game wherein comprising:
a set of one or more game spaces;
a set of one or more advertising objects located within the game spaces;
a set of one or more players interacting with advertising objects in the game spaces while playing the game; and
an alpha player directing game play near the advertising objects.

2. The interactive game of claim 1, wherein the alpha player directs game play by providing clues to the set of players.

3. The interactive game of claim 1, wherein the alpha player directs game play by providing riddles to the set of players.

4. The interactive game of claim 3, wherein the riddles are trivia questions.

5. The interactive game of claim 4, wherein the trivia questions relate to an advertisement of a game sponsor.

6. The interactive game of claim 3, wherein the riddles are portions of an advertisement of a game sponsor and a correct answer is a completion of the advertisement.

7. The interactive game of claim 1, wherein the set of players subscribe to be eligible to play the interactive game.

8. The interactive game of claim 1, wherein the advertising objects include information about a sponsor.

9. The interactive game of claim 1, wherein the advertising objects include products from a sponsor.

10. The interactive game of claim 1, wherein the advertising objects include advertisements from a sponsor.

11. The interactive game of claim 1, wherein the game spaces include public places.

12. The interactive game of claim 11, wherein the public places include Times Square.

13. The interactive game of claim 1, wherein the game spaces include trade shows.

14. The interactive game of claim 13, wherein the trade shows include toy trade shows.

15. The interactive game of claim 1, wherein the game spaces include college campuses.

16. The interactive game of claim 1, wherein the game spaces include theme parks.

17. The interactive game of claim 1, wherein the game spaces include wild-life areas.

18. The interactive game of claim 1, wherein the alpha player directs the game by generating puzzles.

19. The interactive game of claim 18, wherein the alpha player generates a first number of puzzles.

20. The interactive game of claim 19, wherein the players solve a first number of the puzzles to successfully complete the game.

21. The interactive game of claim 19, wherein an additional second number of puzzles are generated by one or more of the players.

22. The interactive game of claim 21, wherein the players solve a first number of the puzzles to successfully complete the game.

23. The interactive game of claim 22, wherein the alpha player changes the first number of puzzles to alter characteristics of the game.

24. The interactive game of claim 1, further comprising a treasure chest, wherein the game is completed by ascertaining a keyword which opens the treasure chest to reveal a prize.

25. A method of providing a game, the method comprising providing a one or more game spaces, each game space including at least one advertising object and a clue involving the advertising object, wherein upon solving the clue, a player proceeds from one game space to another game space.

26. The method of claim 25, wherein knowledge of the game spaces are communicated to players located in a cell zone of the game space.

27. The method of claim 25, wherein solving the at least one clue is accomplished in a cross-channel manner.

28. The method of claim 27, wherein the cross-channel manner utilizes a cellular telephone.

29. The method of claim 27, wherein the cross-channel manner utilizes a wireless personal digital assistant.

30. The method of claim 27, wherein the cross-channel manner utilizes an Internet-connected computer.

31. The method of claim 27, wherein the cross-channel manner utilizes a pay telephone.

32. The method of claim 27, wherein the cross-channel manner utilizes an Internet web browser.

33. The method of claim 27, wherein the cross-channel manner utilizes an Internet appliance.

34. The method of claim 33, wherein the Internet appliance is an interactive television.

35. The method of claim 27, wherein the cross-channel manner includes interfacing with users of a chat room.

36. The method of claim 27, wherein the cross-channel manner includes interfacing with other players to determine a viability of dating.

37. The method of claim 27, wherein the cross-channel manner includes providing an advertising profile to enter a solution to the clue.

38. The method of claim 27, wherein the clue is provided free of charge after the player listens to an advertisement.

39. The method of claim 27, wherein the clue is provided on a cost-basis without listening to an advertisement.
